(19) United States
(12) Patent Application Publication
(10) Pub. No.: US 2019/0240912 A1
(43) Pub. Date: Aug. 8, 2019

(54) 3D PRINTING ROBOT, 3D PRINTING ROBOT SYSTEM, AND METHOD FOR PRODUCING AN OBJECT USING AT LEAST ONE SUCH 3D PRINTING ROBOT

(71) Applicant: Ford Global Technologies, LLC, Dearborn, MI (US)

(72) Inventor: Bruno Alves, Huerth (DE)

(73) Assignee: Ford Global Technologies, LLC, Dearborn, MI (US)

(21) Appl. No.: 16/265,147

(22) Filed: Feb. 1, 2019

(30) Foreign Application Priority Data
Feb. 7, 2018 (DE) 102018201899.5

(51) Int. Cl. B29C 64/393; B33Y 10/00; B33Y 30/00; B33Y 50/02; B29C 64/106; B29C 64/20

(52) U.S. Cl. CPC B29C 64/393; B33Y 10/00; B29C 64/20; B33Y 50/02; B29C 64/106; B33Y 30/00

(57) ABSTRACT

A mobile 3D printing robot includes a robot arm, a stand unit for the temporary setup of the robot arm on an underlying surface, and at least one 3D printing device having at least one printhead which is movable the robot arm and dispenses at least one printing material. An electronic control unit actuates the 3D printing device and a receiving unit of a global navigation satellite system is connected at a predetermined fixed distance in relation to the printhead. The electronic control unit executes the actuation of the 3D printing device as a function of data of the receiving unit such that printing material is dispensed at a first printing position. Also, a drive unit moves the 3D printing robot from the first printing position on the underlying surface into at least one second printing position on the underlying surface where printing material is dispensed.

### CROSS-REFERENCE TO RELATED APPLICATIONS

This application claims priority to and the benefit of German Application 102018201899.5, filed on Feb. 7, 2018. The disclosure of the above application is incorporated herein by reference.

### FIELD

The present disclosure relates to a mobile 3D printing robot. The present disclosure furthermore relates to a mobile 3D printing robot system and a method for producing an object using at least one such mobile 3D printing robot.

### BACKGROUND

The statements in this section merely provide background information related to the present disclosure and may not constitute prior art.

Combining satellite-based position determination systems, which are based on a global navigation satellite system, for example, NAVSTAR GPS (Global Positioning System), with greatly varying, nonstationary devices and machines and using data of the satellite-based position determination system in the operation of the devices and machines is known from the prior art.

For example, U.S. Pat. No. 8,994,519 B1 describes a system for removing vegetation, which is capable of removing vegetation from irrigation canals, rivers, ponds, lakes, swamps, and other water systems, in which the growth of the vegetation obstructs the water flow or the access to water or in which the desire exists to remove undesired vegetation. The vegetation removal system has a system of rakes, which enables the vegetation to be removed while water and silt or mud flow through the rakes and substantially remain as part of the embankment or the bottom of the body of water. Sensors which are attached to the vegetation removal system can provide a location detection for the operator and determine the position and orientation of the rake when the rake is underwater or operates in the vicinity of obstructions. At least one of the sensors can be designed as a GPS sensor.

Furthermore, a method for calibrating the position of a construction machine in a construction site plan is proposed in EP 2 866 053 A1. The method comprises the following steps: a. displaying the construction site plan on a display device of the construction machine; b. outputting an instruction to a construction machine driver, to move a specific part (reference part) of the construction machine to at least one specific location (control point), the coordinates of which are known in the coordinate system of the construction site plan; c. moving the reference part to the control point; d. registering the position of the reference part at the control point by means of a global position determination system in the coordinates of the global position determination system; e. ascertaining coordinate transformation parameters in consideration of the registered coordinates of the global positioning system at the control point and the known coordinates of the control point of the construction site plan.

U.S. Publication No. 2013/0054097 A1 describes a system for use in work machines, which determines the location of the work machine by means of a GPS system as a position determination system and compares its location to the specified location of underground supply devices. The system furthermore supplies notifications when a work device of the work machine enters an exclusion zone in the vicinity of the underground supply devices.

U.S. Pat. No. 8,073,566 B2 proposes an automated stringline installation system for the installation of stringlines for guiding conventional roadbuilding machines. The stringline installation system includes a vehicle, a 3D control system at least partially carried by the vehicle for determining items of location information, and an adjustable arm arrangement installed on the vehicle, which identifies the location of a relative point in a stringline installation and uses items of location information for this purpose, which have been determined by the 3D control system. The 3D control system has a GPS unit. The adjustable arm arrangement includes a working arm having a proximal end and a distal end, a cord which is dispensed by the working arm for use in a stringline installation, and a sensor for determining items of information with respect to the position of the distal end of the working arm arrangement in relation to the proximal end of the working arm.

Furthermore, combining GPS-based position determination systems with stationary manufacturing devices which have a 3D printer is known in the prior art.

Thus, for example, WO 2017/108071 A1 describes a method and a device for producing an object using a 3D printing device. The 3D printing device has at least one printhead having a delivery device, wherein the delivery device is configured to place printing compounds at target positions in order to create the object in a generative manner. In particular, it is provided in this case that the position of the printhead is continuously ascertained by a position measuring unit, and the printing compounds are placed by the delivery device in dependence on the continuously ascertained position of the printhead. The position measuring unit can preferably have at least one step counter on a motor, a rotary encoder, optical scale, in particular a glass scale, GPS sensor, radar sensor, ultrasound sensor, LIDAR (Light Detection and Ranging) sensor, and/or at least one light barrier.

To position the printhead in relation to a base plate, the 3D printing device comprises three positioning units, wherein each of these positioning units enables a movement in respectively one of the three (Cartesian) spatial axes X, Y, and Z. Each of the positioning units is connected for this purpose to an axis, along which a movement is enabled. A working region of the 3D printing device is essentially restricted to the space between the base plate and the positioning units.

A three-dimensional printer (3D printer) having at least one independently movable printing robot is known from U.S. Publication No. 2017/0144377 A1. Each of the at least one printing robots comprises a printhead for the printing of printing material to execute 3D printing commands, wherein a position determination unit can register a position of the printhead. A processor can have a data connection to the printhead and the position determination unit. The processor is used for the purpose of wirelessly receiving the 3D printing commands, requesting the registered position of the printhead from the position determination unit, and actuating the printhead to set the position of the printhead to print out the printing material based on the received 3D printing commands. Each of the at least one printing robots furthermore includes at least three robot legs. The at least three robot legs are capable of being arranged on a worktable to support the weight of the at least one printing robot during the 3D printing.

A suspension system, which is arranged spaced apart vertically from the flat, horizontal work surface of the worktable, is provided for positioning the printhead. The printing robot contains a cable pull on a coil, by means of which the at least one printing robot can be raised via the suspension system by winding up a thread or wire in order to move the at least one printing robot rapidly to a further point of the worktable. For further positioning of the printhead, the printing robot furthermore includes a rotation rate sensor, which is used to adjust a printing angle of the printhead in relation to the horizontal. A working region of the 3D printer is essentially restricted to the space below the suspension system.

Moreover, combinations of nonstationary devices or machines which comprise a 3D printing technology with GPS-based position determination systems are known from the prior art. In these combinations, a working region of the 3D printing technology is not restricted to a size of a base plate or a worktable.

Thus, a method for preparing and/or modifying an observed work surface is proposed in U.S. Publication No. 2017/0226709 A1, from which a level surface layer results. In one form, a three-dimensional (3D) road paver is used to dispense a compressible road covering material, wherein the road covering has a layer thickness before a mechanical compaction which varies in accordance with a height profile of the underground surface. Road paving methods provided here, which comprise a 3D printing technology to deposit a compressible road covering material of choice, advantageously enable a more effective, more cost-effective, and more multifaceted solution in the production of level road surface layers than existing road pavers. The method includes the provision of a three-dimensional (3D) mapping of the height profile of the worksurface using a scanner system, wherein the height profile comprises a collection of 3D coordinates on the surface of the worksurface. The scanner system can include, for example, a GPS system.

Methods and manufacturing devices which enable mobile additive manufacturing methods and the application thereof for producing advanced building structures and advanced roads are known from WO 2016/168314 A1.

The mobile additive manufacturing device includes a controller, which can execute algorithms and provide control signals, and an additive production method for depositing at least one first material at predetermined locations over a surface according to a first digital model worked out by the controller. The material can contain, for example, rock and asphalt as binders. The additive manufacturing system furthermore includes an arrangement of material distribution elements, wherein material distribution elements are placed in the arrangement at least along two spatial axes different from one another, wherein the material distribution element has an electroactive actuator. The mobile additive manufacturing device furthermore has a drive system, which can transport the additive manufacturing device along the surface, a navigation system for determining a location of the additive manufacturing device and for guiding the drive system, and a power supply system, which is capable of providing power in order to operate at least the drive system, the navigation system, control system, and the additive manufacturing device. The navigation system can have a sensor element which is based on GPS technology.

Furthermore, a robotic prototype which combines additive layer production technologies with flying robots is known from the article by Graham Hunt et al., “3D printing with flying robots”, 2014 IEEE International Conference on Robotics and Automation (ICRA), Hong Kong, 2014, pp. 4493-4499. The article describes the design and the characterization of a 3D air printer and a flying robot which is capable of depositing expanding polyurethane foam during flight. The design includes a lightweight printer module on a quadrocopter. Examples of possible applications are emergency aid structures in search and rescue scenarios and the printing of structures for bridging chasms in impassable terrain.

### SUMMARY

In consideration of the prior art described, the field of nonstationary manufacturing devices having 3D printers and navigation satellite-based position determination systems still offers room for improvements.

The present disclosure provides a nonstationary manufacturing device having a 3D printer and navigation satellite-based position determination system that produces objects with a size of multiple meters by 3D printing.

It is to be noted that the features and measures specified individually in the following description can be combined with one another in any desired technically reasonable manner and disclose further forms of the present disclosure. The description additionally characterizes and specifies the present disclosure in particular in conjunction with the figures.

The mobile 3D printing robot according to the teachings of the present disclosure includes a robot arm and a stand unit for the temporary setup of the robot arm on an underlying surface. The mobile 3D printing robot furthermore has at least one 3D printing device having at least one printhead which is movable by the robot arm. The 3D printing device is provided for dispensing at least one printing material. An electronic control unit of the mobile 3D printing robot according to the present disclosure is provided at least for actuating the 3D printing device.

The mobile 3D printing robot according to the teachings of the present disclosure furthermore includes a receiving unit of a global navigation satellite system, which is connectable at a predetermined, fixed distance in relation to the printhead. In this case, the electronic control unit is furthermore provided for the purpose of executing the actuation of the 3D printing device as a function of data of the receiving unit.

The term “provided for the purpose” is to be understood in the meaning of this present disclosure in particular as especially programmed, designed, or arranged for this purpose.

The mobile 3D printing robot according to the teachings of the present disclosure can be used to produce very large objects, the production of which using conventional 3D printers would require excessively large and accordingly heavy suspension devices and/or mounts, with the consequence of a disadvantageously large material and part expenditure and an immobility of the 3D printer. The term “very large object” is to be understood in the meaning of this present disclosure as objects in which at least one linear dimension is a multiple of a linear dimension of the mobile 3D printing robot in the same direction.

In one form, the robot arm has multiple parts connected to one another by joints so they are movable in relation to one another.

In one form, the receiving unit is rigidly connectable at the predetermined fixed distance in relation to the printhead. The receiving unit can be rigidly connectable, for example, to the robot arm or a part of the robot arm which is coupled to the at least one printhead.

In some aspects of the present disclosure, the 3D printing device is provided for the layer-by-layer dispensing of the at least one printing material.

In advantageous forms of the mobile 3D printing robot, a drive unit is provided for moving the 3D printing robot from a first printing position on the underlying surface into at least one second printing position on the underlying surface. The 3D printing robot can be moved in a particularly simple manner into successive printing positions by the drive unit, whereby an accelerated and automated work sequence can be achieved during the production of a large object.

The terms “first”, “second”, etc. used in the present disclosure serve only for the purpose of differentiation. In particular, no sequence or priority of the objects mentioned in conjunction with these terms is to be implied by the use thereof.

In some aspects of the present disclosure, the robot arm has a range which is sufficient to produce objects or object parts from the at least one printing material, which have a dimension in at least one direction which is greater than a maximum dimension of the 3D printing robot in this direction. A particularly rapid production of a large object can be achieved in this way.

In some aspects of the present disclosure, the robot arm has a range which is sufficient to produce objects or object parts, the footprint of which on the underlying surface is arranged outside a footprint of an imaginary envelope of the stand unit projected perpendicularly onto the underlying surface. A production of objects, which are immobile after the production thereof because of the size and the weight thereof, at the destination thereof can thus be enabled.

In one form of the 3D printing robot, the robot arm is mounted so it is rotatable in the stand unit. A compact construction of the 3D printing robot and a larger working region of the 3D printing device can thus be achieved.

In some aspects of the present disclosure, the robot arm is mounted in the stand unit about a vertically arranged axis.

In one form of the 3D printing robot, the receiving unit is provided for receiving a global navigation satellite system (GNSS), which is designed as a differential global position determination system (DGPS). A positioning accuracy of the 3D printing device can thus be increased. Such position determination systems use methods for increasing the accuracy of the navigation using GNSS. The GNSS can be formed, for example, by the future Galileo system, in which the increase of the accuracy of the position determination can be performed by the European Geostationary Navigation Overlay Service (EGNOS).

In one form of the 3D printing robot, the stand unit has a plurality of at least three stand legs, which are arranged originating radially from a center axis, wherein each of the stand legs has multiple parts connected by joints to be movable in relation to one another. In this manner, the 3D printing robot can compensate for height differences of the underlying surface in the case of uneven terrain, whereby reliable positioning can be enabled there.

In some aspects of the present disclosure, an axis of rotation of the robot arm in the stand unit corresponds to the center axis of the stand unit.

In some aspects of the present disclosure, the stand legs are formed at least partially in structural light construction (also: construction light construction) and/or in material light construction (also: substance light construction).

In a further aspect of the present disclosure, a mobile 3D printing robot system is proposed, which has at least two mobile 3D printing robots according to the teachings of the present disclosure and at least one electronic main control unit, which has a data connection to the electronic control units of the at least two mobile 3D printing robots. In such an aspect, the electronic main control unit is provided for the purpose of specifying predetermined parameters for the joint production of an object to the electronic control units of the at least two mobile 3D printing robots.

The predetermined parameters can include, without being restricted thereto, target positions of the receiving units at predefined positions of the robot arms and/or parameters for actuating the 3D printing devices of the at least two mobile 3D printing robots for producing an object.

Objects can be produced in a time-optimized manner by the mobile 3D printing robot system disclosed in the present disclosure by way of a corresponding selection of the predetermined parameters.

In some aspects of the present disclosure, the electronic control units and the electronic main control unit can each have at least one processor unit and a digital data storage unit, to which the processor unit has data access. In this manner, a semiautomatic or automatic and reliable execution of procedures for which the electronic control units and the electronic main control unit are provided can be enabled.

For example, the respective processor units and/or digital data storage units can be parts of microcontrollers. Such microcontrollers are presently commercially available in many variations at reasonable prices. The predetermined parameters disclosed in this application can advantageously be saved in the digital storage unit, whereby a more rapid data access can be achieved.

In a further aspect of the present disclosure, a method is proposed for producing an object using at least one mobile 3D printing robot according to the present disclosure or a mobile 3D printing robot system according to the present disclosure.

The method is characterized by at least the following steps, which are to be executed by each of the mobile 3D printing robots:
reading out predefined parameters, executed by the electronic control unit, for producing the object, wherein the predefined parameters include at least a plurality of target positions of the receiving unit of the at least one mobile 3D printing robot;
ascertaining an actual position of the printhead from the data of the receiving unit;
based on the ascertained actual position, assuming a first target position of the receiving unit within a predetermined tolerance interval;
dispensing at least one printing material at all target positions of the printing material, which are provided at the first target position of the receiving unit;
assuming a second target position of the receiving unit within a predetermined tolerance interval;
dispensing the at least one printing material at all target positions of the printing material, which are provided at the second target position of the receiving unit; and
repeating the steps of assuming a next target position of the receiving unit and dispensing the at least one printing material at all target positions of the printing material which are provided at the next target position of the receiving unit until the at least one printing material is dispensed at all predetermined target positions of the printing material.

The advantages described in conjunction with the mobile 3D printing robot according to the present disclosure and/or the mobile 3D printing robot system according to the present disclosure are applicable in their entirety to the proposed method for producing an object.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows a schematic, perspective illustration of a mobile 3D printing robot according to the teachings of the present disclosure;

FIG. 2 shows a block diagram of a mobile 3D printing robot system according to the teachings of the present disclosure;

FIG. 3 shows a schematic, perspective illustration of a mobile 3D printing robot having an alternative stand unit and an alternative robot arm during the production of an object according to the teachings of the present disclosure; and

FIG. 4 shows a flow chart of a method for producing an object using a mobile 3D printing robot according to FIG. 1 according to the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

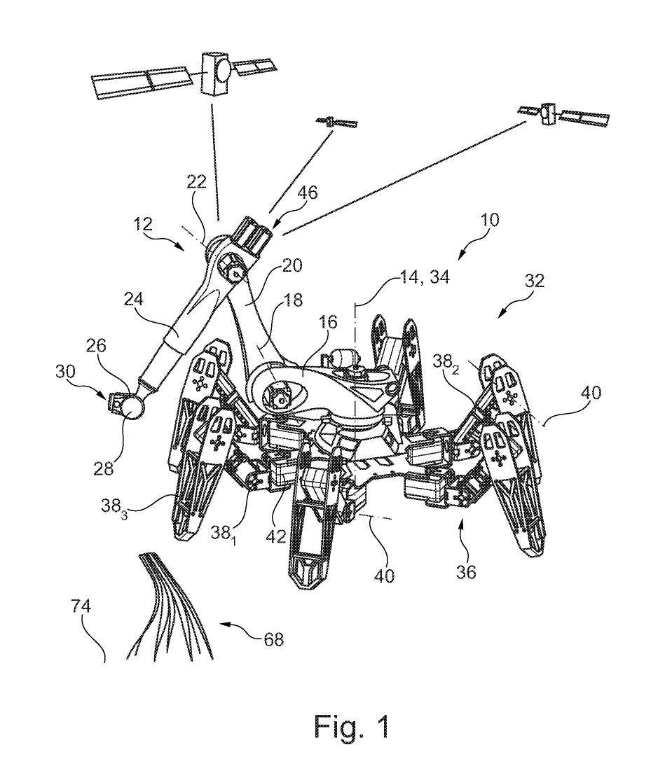

FIG. 1 shows a schematic, perspective illustration of a mobile 3D printing robot 10 according to the teachings of the present disclosure.

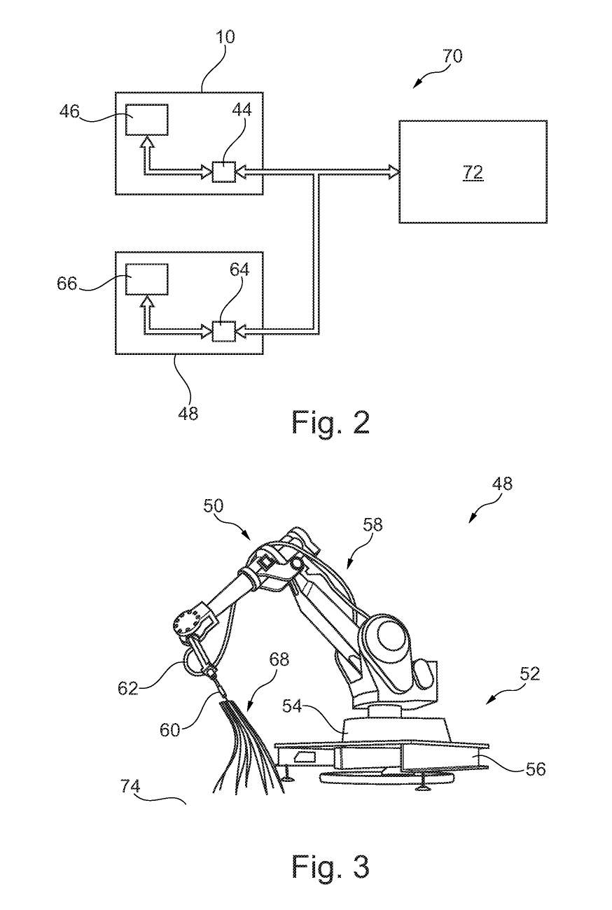

The mobile 3D printing robot 10 includes a robot arm 12, which has four parts 16, 20, 24, 28 connected by joints so they are movable in relation to one another, of which three parts 16, 20, 24 connected in series are essentially formed in an oblong shape. The first oblong part 16 of the robot arm 12, which is arranged lowermost, is mounted so it is rotatable about a vertically arranged axis of rotation 14 in a central part of a stand unit 32. An end of the first part 16 facing away from the stand unit 32 is coupled to an end of the second part 20 of the four parts 16, 20, 24, 28 so it is pivotable, wherein a pivot axis 18 is arranged horizontally. An end of the second part 20 facing away from the first part 16 is also coupled to an end of a third part 24 of the four parts 16, 20, 24, 28 so it is pivotable, wherein a pivot axis 22 is arranged horizontally. The third part 24 of the four parts 16, 20, 24, 28 is formed as a longitudinally-adjustable telescopic arm. The fourth part 28 is connected to the third part 24 via a ball joint 26 so it is movable. The mobile 3D printing robot 10 includes a 3D printing device, which is provided for dispensing a printing material and has a printhead 30. The fourth part 28 is used for holding the printhead 30, which is thus movable by the robot arm 12. A drive assembly (not shown) of the 3D printing robot 10 is provided for the purpose of effectuating a predetermined movement of the robot arm 12. The 3D printing robot 10 is equipped with an electronic control unit 44 (FIG. 2), which is provided, inter alia, for actuating the 3D printing device and includes a microcontroller, which has a processor unit and a digital data storage unit.

With reference to FIG. 1, the stand unit 32 is used for the temporary setup of the robot arm 12 on an underlying surface 74, and has a plurality of stand legs 36 (e.g., six stand legs), which are spaced apart uniformly along a circumferential line about a center axis 34, which corresponds to the vertically arranged axis of rotation 14 of the robot arm 12, and are arranged originating radially from the center axis 34. Each stand leg 36 of the plurality of six stand legs 36 has three parts 38₁, 38₂, 38₃ connected by joints so they are movable in relation to one another, wherein the pivot axes 40 of the joints are arranged horizontally. Each of the six stand legs 36 is coupled by a part 38₁, which faces toward a central part of the stand unit 32, to a separate cantilever 42 of the central part, wherein each pivot axis between the cantilever and the respective part 38₁ is aligned in the vertical direction.

Due to the pivotable arrangement of the parts 38₁, 38₂, 38₃, the six stand legs 36 can compensate for irregularities of the underlying surface 74, in order to move the central part of the stand unit 32 in a horizontal position and keep it in position after locking the pivot joints.

The six stand legs 36 are partially formed in structural light construction and in material light construction, by parts of the stand legs 36 being manufactured from multiply perforated plate elements, which are partially formed as struts, and being produced from an aluminum alloy.

The mobility of the 3D printing robot 10 enables the 3D printing robot 10 to be moved from a first printing position on the underlying surface 74 into further printing positions on the underlying surface 74. In alternative forms, the 3D printing robot 10 can be equipped with a drive unit, which is provided for moving the 3D printing robot 10 from a first printing position on the underlying surface 74 into at least one second printing position on the underlying surface 74. The drive unit can be identical to the drive assembly of the 3D printing robot 10 for moving the robot arm 12.

The mobile 3D printing robot 10 is equipped with a receiving unit 46 for receiving a global navigation satellite system (GNSS), which is designed as a differential global position determination system (DGPS) and which can be formed, for example, by the future Galileo navigation satellite system. An increase of the position measuring accuracy can be performed by the European Geostationary Navigation Overlay Service (EGNOS). The receiving unit 46 is fixedly coupled to the third part 38₃ of the robot arm 12 and at a predetermined, fixed distance in relation to the printhead 30, and therefore the position of the printhead 30 can be ascertained from received data of the receiving unit 46.

The electronic control unit 44 has a data connection to the receiving unit 46 and is provided for the purpose of executing the actuation of the 3D printing device as a function of data of the receiving unit 46, as shown hereafter.

The robot arm 12 has a range as a result of the pivot ranges or the extension range, respectively, of the three parts 38₁, 38₂, 38₃, which is sufficient to produce objects or object parts 68 from the printing material, which have a dimension in a lateral direction which is greater than a maximum dimension of the 3D printing robot 10 in this direction. The range of the robot arm 12 is also sufficient to produce objects or object parts 68, the footprint of which on the underlying surface 74 is arranged outside a footprint of an imaginary envelope of the stand unit 32 projected perpendicularly onto the underlying surface 74.

This is also shown in FIG. 3, which shows a mobile 3D printing robot 48 having an alternative robot arm 50 and an alternative stand unit 52 during a production of an object 68, which includes a plurality of metal struts. The alternative stand unit 52 for the temporary setup of the robot arm 50 on the underlying surface 74 includes a substantially cylindrical stand base part 54, which is arranged on a surface of a steel girder structure 56 having compensation elements for the horizontal positioning of the cylindrical stand base part 54.

In FIG. 3, the 3D printing device 58 of the mobile 3D printing robot 48 is shown in an operationally ready state having a printhead 60 and a supply line 62 for supplying the printhead 60 with printing material.

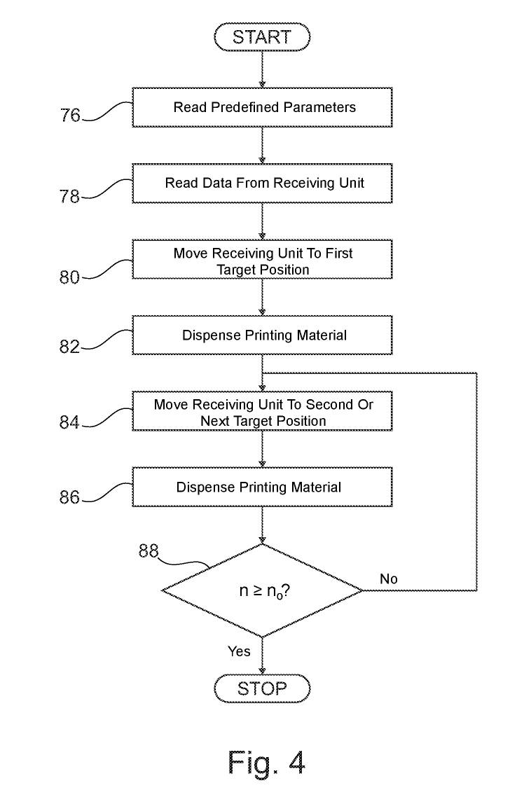

One possible form according to the present disclosure of a method for producing an object 68 using the mobile 3D printing robot 10 will be described hereafter on the basis of FIGS. 1 and 2. A flow chart of the method is shown in FIG. 4.

The electronic control unit 44 is provided for the semiautomatic execution of the method and contains for this purpose a software module for the automatic execution of various steps of the method, wherein these method steps to be executed are provided as executable program code, which is stored in the digital data storage unit of the microcontroller of the electronic control unit 44 and can be executed by the processor unit of the microcontroller of the electronic analysis unit 44.

In preparation for carrying out the method, it is presumed that all participating devices and components are in an operationally-ready state.

In a step 76 of the method, the predefined parameters for producing the object 68 are read out from the digital data storage unit by the electronic control unit 44. The predefined parameters contain a plurality of target positions of the receiving unit 46 of the mobile 3D printing robot 10 and parameters for actuating the 3D printing device of the 3D printing robot 10 for each target position of the plurality of target positions for producing the object 68.

In a further step 78, the electronic control unit 44 reads out data of the receiving unit 46 and ascertains an actual position of the printhead 30. For this purpose, the printhead 30 can be moved by the robot arm 12 into a base position. Based on the ascertained actual position of the printhead 30, the mobile 3D printing robot 10 is moved in a next step 80 such that the receiving unit 46 assumes a first target position of the receiving unit 46 within a predetermined tolerance interval.

In a subsequent step 82 of the method, the 3D printing device is actuated by the electronic control unit 44 such that the printing material is dispensed at all target positions of the printing material which are provided at the first target position of the receiving unit 46. The dispensing of the printing material can take place layer-by-layer, for example, at all target positions of the receiving unit 46.

The mobile 3D printing robot 10 is subsequently moved in a further step 84 such that the receiving unit 46 assumes a second or next target position of the receiving unit 46 within a predetermined tolerance interval. A further determination of the actual position of the printhead 30 can be performed beforehand in an optional step by the electronic control unit 44, on which the movement of the mobile 3D printing robot 10 to the second target position of the receiving unit 46 is based. The predetermined tolerance interval can be identical for all target positions of the plurality of target positions of the receiving unit 46. However, the tolerance intervals predetermined for each of the target positions can also be selected differently.

When the second target position of the receiving unit 46 is reached, the 3D printing device is actuated in a further step 86 by the electronic control unit 44 such that the printing material is dispensed at all target positions of the printing material, which are provided in the case of the second target position of the receiving unit 46.

The steps of assuming a next target position (step 84) from the plurality of target positions of the receiving unit 46 and actuating the 3D printing device to dispense the at least one printing material (step 86) at all target positions of the printing material, which are provided in the case of the next target position from the plurality of target positions of the receiving unit 46, are repeated until the printing material is dispensed at all predetermined target positions of the printing material. The execution of all target positions of the plurality of target positions is checked by a comparison step 88. That is, if there are a total of ‘nₒ’ target positions for which the printhead 30 dispenses printing material, the method compares the number of target positions ‘n’ for which the printhead 30 has dispensed printing material to the total target positions nₒ. If n is less than nₒ, the method returns to step 84 and executes steps 84 and 86 again. If n is equal to nₒ the method stops.

In some aspects of the present disclosure, the mobile 3D printing robot 10 is equipped with a drive unit, which is provided for moving the mobile 3D printing robot 10 from a first printing position on the underlying surface 74 into further printing positions on the underlying surface 74, and the above-described method is executed fully automatically instead of semiautomatically, whereby the workflow is substantially accelerated. In such aspects, the electronic control unit 44 is provided for the purpose of actuating the drive unit such that the receiving unit 46 assumes the target positions of the receiving unit 46 within predetermined tolerance intervals.

The object can also be produced using more than one mobile 3D printing robot. FIG. 2 shows a schematic illustration of a mobile 3D printing robot system 70, which has two mobile 3D printing robots 10, 48 and an electronic main control unit 72. The electronic main control unit 72 includes a processor unit and a digital data storage unit and has a data connection to the electronic control units 44, 64 of the two mobile 3D printing robots 10, 48. The electronic main control unit 72 is provided for the purpose of specifying predetermined parameters for the joint production of an object to the electronic control units 44, 64 of the two mobile 3D printing robots 10, 48.

The above described method steps are then to be executed using each of the two mobile 3D printing robots 10, 48.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A mobile 3D printing robot comprising:
a robot arm;
a stand unit for the temporary setup of the robot arm on an underlying surface;
at least one 3D printing device having at least one printhead which is movable by the robot arm and is provided for dispensing at least one printing material;
an electronic control unit, which is provided at least for actuating the 3D printing device; and
a receiving unit of a global navigation satellite system which is connectable at a predetermined fixed distance in relation to the printhead,
wherein the control unit is furthermore provided for the purpose of executing the actuating of the 3D printing device as a function of data of the receiving unit.

2. The mobile 3D printing robot according to claim 1, wherein a drive unit is provided for moving the 3D printing robot from a first printing position on the underlying surface into at least one second printing position on the underlying surface.

3. The mobile 3D printing robot according to claim 1, wherein the robot arm has a range which is sufficient to produce objects or object parts from the at least one printing material which have a dimension in at least one direction which is greater than a maximum dimension of the 3D printing robot in this direction.

4. The mobile 3D printing robot according to claim 1, wherein the robot arm has a range which is sufficient to produce objects or object parts, the footprint of which on the underlying surface is arranged outside a footprint of an imaginary envelope of the stand unit projected perpendicularly onto the underlying surface.

5. The mobile 3D printing robot according to claim 1, wherein the robot arm is mounted so it is rotatable in the stand unit.

6. The mobile 3D printing robot according to claim 1, wherein the receiving unit is provided for receiving a global navigation satellite system which is designed as a differential global position determination system.

7. The mobile 3D printing robot according to claim 1, wherein the stand unit has at least three stand legs which are arranged originating radially from a center axis, wherein each of the stand legs has multiple parts connected by joints so they are movable in relation to one another.

8. The mobile 3D printing robot according to claim 7, wherein the stand legs are formed at least partially in structural light construction and/or in material light construction.

9. A mobile 3D printing robot system comprising:
at least two mobile 3D printing robots, wherein each of the at least two mobile 3D printing robots comprise:
a robot arm;
a stand unit for the temporary setup of the robot arm on an underlying surface;
at least one 3D printing device having at least one printhead which is movable by the robot arm and is provided for dispensing at least one printing material;
an electronic control unit, which is provided at least for actuating the 3D printing device; and
a receiving unit of a global navigation satellite system which is connectable at a predetermined fixed distance in relation to the printhead; and
at least one electronic main control unit which has a data connection to the electronic control units of the at least two mobile 3D printing robots and is provided for the purpose of specifying predetermined parameters for the joint production of an object to the electronic control units of the at least two mobile 3D printing robots.

10. A method for producing an object using at least one mobile 3D printing robot, the method comprising:
reading out predefined parameters, executed by an electronic control unit, for producing the object, wherein the predefined parameters include at least a plurality of target positions of a receiving unit of at least one mobile 3D printing robot, wherein each of the at least one mobile 3D printing robots comprise:
a robot arm;
a stand unit for the temporary setup of the robot arm on an underlying surface;
at least one 3D printing device having at least one printhead which is movable by the robot arm and is provided for dispensing at least one printing material;
an electronic control unit, which is provided at least for actuating the 3D printing device; and
a receiving unit of a global navigation satellite system which is connectable at a predetermined fixed distance in relation to the printhead;
ascertaining an actual position of a printhead from the data of the receiving unit;
based on the ascertained actual position, assuming a first target position of the receiving unit within a predetermined tolerance interval;
dispensing at least one printing material at all target positions of the printing material which are provided at the first target position of the receiving unit;
assuming a second target position of the receiving unit within a predetermined tolerance interval;
dispensing the at least one printing material at all target positions of the printing material which are provided at the second target position of the receiving unit; and
repeating the steps of assuming a next target position of the receiving unit and dispensing the at least one printing material at all target positions of the printing material which are provided at the next target position of the receiving unit, until the at least one printing material is dispensed at all predetermined target positions of the printing material.
